(19) United States
(12) Patent Application Publication
(10) Pub. No.: US 2018/0037223 A1
(43) Pub. Date: Feb. 8, 2018

(54) AUTONOMOUS DRIVING ASSISTANCE SYSTEM, AUTONOMOUS DRIVING ASSISTANCE METHOD, AND COMPUTER PROGRAM

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Hirohiko GOTO, Chiryu (JP); Yuji SATO, Owariasahi (JP); Kuniaki TANAKA, Nagoya (JP); Masaki TAKANO, Susono (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 15/554,684

(22) PCT Filed: Mar. 30, 2016
(86) PCT No.: PCT/JP2016/060545

§ 371 Date: Aug. 30, 2017

(30) Foreign Application Priority Data
Mar. 31, 2015 (JP) 2015-074405

(51) Int. Cl. B60W 30/08; G08G 1/16; B60W 30/14; G05D 1/02; B60W 30/12

(52) U.S. Cl. CPC B60W 30/08; G05D 1/0231; B60W 30/12; B60W 30/14; G08G 1/16

(57) ABSTRACT

Autonomous driving assistance systems, methods, and programs acquire a present location of a vehicle, acquire a road shape of a road where the vehicle travels, and set, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape. The systems, methods, and programs perform the first autonomous driving control or the second autonomous driving control in compliance with the set control content, detect a steering operation by a driver of the vehicle, and continue or stop the first autonomous driving control or the second autonomous driving control on the basis of the detected steering operation, the present location, and the road shape.

### TECHNICAL FIELD

Related technical fields include autonomous driving assistance systems, methods, and programs that assist a vehicle to travel by using autonomous driving control.

### BACKGROUND

As a vehicle traveling mode other than manual traveling in which a vehicle travels in response to a driving operation by a user, nowadays traveling that uses autonomous driving control is newly proposed in which a vehicle autonomously travels along a road or a preset route without a driving operation by a user. In the autonomous driving control, for example, the present location of a vehicle, a lane where the vehicle travels, and locations of other vehicles around are detected at all times, and vehicle control of a steering wheel, a driving source, a brake, etc. is autonomously performed so that the vehicle can travel along a road or a preset route. Although the traveling that uses the autonomous driving control has the advantage of easing the burden on a user in driving, it is difficult for the autonomous driving control to perform all necessary vehicle operations. For example, one approach may be to perform some difficult vehicle operations, such as an operation necessary to make a lane change, by manual driving by a driver.

However, as disclosed in Japanese Patent No. 3094100 (JP 3094100), it is conventional that when a vehicle operation (hereinafter referred to as an override), such as accelerating, braking, or steering performed by a user is detected, the autonomous driving control is basically stopped, and switching to the manual driving is made.

### SUMMARY

According to the technique disclosed in JP 3094100, when the override is detected, regardless of control content of the autonomous driving control being performed and a surrounding environment, all the autonomous driving control being performed is equally stopped, and switching to the manual driving control is made. The problem with JP 3094100 is described with reference to a situation illustrated in FIG. 11. In the situation illustrated in FIG. 11, lanes 65-67 each connect to curves after branching off, and a vehicle 50 travels in the lane 65, out of the lanes 65 to 67. It is assumed that a control subject to Which the autonomous driving control is to be applied is the curve connected to the lane 65, not the curve connected to the lane 66 and the lane 67. In this situation, according to the Patent Document 1, when the vehicle 50 makes a lane change in response to a steering operation by a user, switching occurs from the autonomous driving control to the manual driving control, so that a user does not feel a sense of discomfort. Conversely, it is assumed that the vehicle 50 travels in either the lane 66 or the lane 67, out of the lanes 65 to 67, and that the control subject to which the autonomous driving control is to be applied is the curve connected to the lane 66 and the lane 67. In this situation, according to JP 3094100, when the vehicle 50 makes a lane change from one of the lane 66 and the lane 67 to the other in response to a steering operation by a user, switching occurs from the autonomous driving control to the manual driving control. As a result, although the control subject to which the autonomous driving control is to be applied is the curve connected to the lane 66 and the lane 67, a user needs to perform all the vehicle operations, such as accelerating, braking, and steering. This causes a problem in that although there is an opportunity to case the burden on a user in driving a vehicle by performing the control content of the autonomous driving control that controls the speed of the vehicle, out of the control content of the autonomous driving control that causes the vehicle to travel without deviating from a lane and that controls the speed of the vehicle, the opportunity is missed.

Exemplary embodiments of the broad inventive principles described herein provide an autonomous driving assistance system, an autonomous driving assistance method, and a computer program that determine, on the basis of presence or absence of detection of an override, the shape of a surrounding road, and content of autonomous driving control being performed, whether to continue or stop the autonomous driving control, thus preventing an increase in the burden on a user in driving a vehicle, associated with stopping the autonomous driving control.

Exemplary embodiments provide autonomous driving assistance systems, methods, and programs that acquire a present location of a vehicle, acquire a road shape of a road where the vehicle travels, and set, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape. The systems, methods, and programs perform the first autonomous driving control or the second autonomous driving control in compliance with the set control content, detect a steering operation by a driver of the vehicle, and continue or stop the first autonomous driving control or the second autonomous driving control on the basis of the detected steering operation, the present location, and the road shape.

The autonomous driving assistance system, the autonomous driving assistance method, and the computer program having the above structure determine, on the basis of presence or absence of detection of the steering operation by the driver, the shape of the surrounding road, and the content of the autonomous driving control being performed, whether to continue or stop the autonomous driving control in the vehicle that travels by using the autonomous driving control. Thus, if the steering operation by the driver is detected, there is no possibility that all the autonomous driving control is equally stopped in the same manner as in the related art. This makes it possible to prevent an increase in the burden on the driver in driving the vehicle, associated with stopping the autonomous driving control.

### BRIEF DESCRIPTION OF THE DRAWINGS

FIG. 1 is a block diagram illustrating the structure of a navigation device according to the present embodiment.

FIG. 2 is a flowchart of an autonomous driving start program according to the present embodiment.

FIG. 3 is a flowchart of an autonomous driving control change program according to the present embodiment.

FIG. 4 is a flowchart of the autonomous driving control change program according to the present embodiment.

FIG. 5 illustrates an example case where there is a branch point ahead in the direction of travel of a vehicle and where only part of branching routes has a curve that is a control subject section.

FIG. 6 illustrates an example case where there is a branch point ahead in the direction of travel of a vehicle and where only part of branching routes has a curve that is a control subject section.

FIG. 7 illustrates an example case where ‘speed management (exit road)’ of autonomous driving control is performed in a vehicle.

FIG. 8 illustrates an example situation where, in order to allow a vehicle that travels by using ‘speed management (curve)’ of the autonomous driving control to continue the autonomous driving control, a driver is required to perform a vehicle operation (specifically, a steering operation for making a lane change).

FIG. 9 illustrates an example situation where, in order to allow a vehicle that travels by using the ‘speed management (exit road)’ of the autonomous driving control to continue the autonomous driving control, a driver is not required to perform a vehicle operation (specifically, a steering operation for making a lane change).

FIG. 10 is a diagram illustrating a modification of the autonomous driving control change program.

FIG. 11 illustrates an example case where there is a branch point ahead in the direction of travel of a vehicle and where each branching route has a curve.

### DETAILED DESCRIPTION OF EXEMPLARY EMBODIMENTS

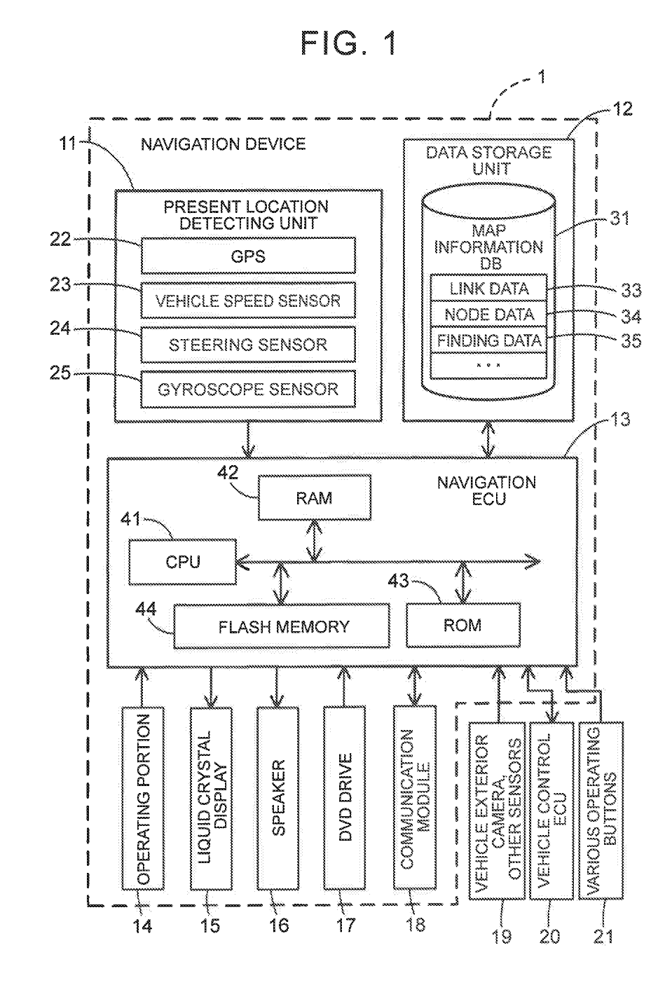

In an embodiment below, a navigation device embodying an autonomous driving assistance system is described in detail with reference to the drawings. First, the general structure of a navigation device 1 according to the present embodiment is described with reference to FIG. 1. FIG. 1 is a block diagram of the navigation device 1 according to the present embodiment.

As illustrated in FIG. 1, according to the present embodiment, the navigation device 1 includes the following: a present location detecting unit 11 that detects the present location of a vehicle equipped with the navigation device 1; a data storage unit 12 that stores various data; a navigation ECU 13 that performs various computations on the basis of input information; an operating portion 14 that receives an operation from a user; a liquid crystal display 15 that displays, to a user, information on a map of an area around the vehicle, a guide route (a route where the vehicle plans to travel) set in the navigation device 1, etc.; a speaker 16 that outputs voice guidance on route guide; a DVD drive 17 that reads a DVD that is a storage medium; and a communication module 18 that communicates with an information center, such as a probe center or a vehicle information and communication system (registered trade mark: VICS) center. (As used herein, the term “storage medium” is not intended to encompass transitory signals.) The navigation device 1 is connected, via an in-vehicle network, such as CAN, to a vehicle exterior camera 19 and various sensors that are mounted on the vehicle equipped with the navigation device 1. Further, the navigation device 1 is bidirectionally communicatively connected to a vehicle control ECU 20 that performs various control of the vehicle equipped with the navigation device 1. Furthermore, the navigation device 1 is connected to various operating buttons 21 that are mounted on the vehicle and that include an autonomous driving start button.

The components of the navigation device 1 are described in turn below. The present location detecting unit 11 includes a GPS 22, a vehicle speed sensor 23, a steering sensor 24, and a gyroscope sensor 25, and is allowed to detect the present location and bearing of the vehicle, the traveling speed of the vehicle, the present time, etc. The vehicle speed sensor 23 is a sensor for detecting the distance traveled by the vehicle and the speed of the vehicle, generates pulses in response to the rotation of driving wheels of the vehicle, and outputs a pulse signal to the navigation ECU 13. The navigation ECU 13 calculates the rotational speed of the driving wheels and the traveled distance by counting the number of generated pulses. It is noted that the navigation device 1 is not required to include all the four types of sensors and that the navigation device 1 may include only one or a few types of sensors among them.

The data storage unit 12 includes a hard disk (not illustrated), serving as an external storage device and a recording medium, and a recording head (not illustrated), serving as a driver for reading a map information DB 31 and prescribed programs recorded on the hard disk and for writing given data on the hard disk. Instead of the hard disk, the data storage unit 12 may include a flash memory, a memory card, an optical disc, such as a CD or DVD, etc. Alternatively, the map information DB 31 may be stored in an external server, and the navigation device 1 may acquire the map information DB 31 via communication.

The map information DB 31 is storage means for storing, for example, link data 33 related to roads (links), node data 34 related to node points, finding data 35 used for route finding, facility data related to facilities, map display data used to display a map, intersection data related to intersections, and search data used for location searching.

Data recorded as the link data 33 includes the following: data on each link that forms a road to Which the link belongs, namely data indicating the width, slope, cant, and bank of the road, the road surface condition, a merging section, the number of lanes on the road, the location where the number of lanes decreases, the location where the road width decreases, a railroad crossing, etc.; data on a corner, namely data indicating the radius of curvature, an intersection, a T-junction, the entrance and exit of the corner, etc.; data on road attributes, namely data indicating a downhill road, an uphill road, etc.; and data on road type, namely data indicating a local road, such as a national road, a prefectural road, or a narrow street, and a toll road, such as a national highway, an urban highway, an exclusive automobile road, a local toll road, or a toll bridge.

Data recorded as the node data 34 includes data on the following: a branch point (including an intersection and a T-junction) of an actual road; coordinates (locations) of node points set at predetermined intervals on each road in accordance with the radius of curvature, etc.; node attributes indicating whether a node corresponds to an intersection, etc.; a connection link number list that lists link numbers of links connecting to the node; an adjacent node number list that lists node numbers of nodes located adjacent to the node across a link; and the height (altitude) of each node point.

Data recorded as the finding data 35 includes various data used for route finding that finds a route from a departure point (e.g., the present location of a vehicle) to a set destination. Specifically, cost calculation data used to calculate finding costs, such as a cost (hereinafter referred to as an intersection cost) obtained by quantifying the degree of suitability of a route for an intersection and a cost (hereinafter referred to as a link cost) obtained by quantifying the degree of suitability of a route for a link that forms a road, is stored.

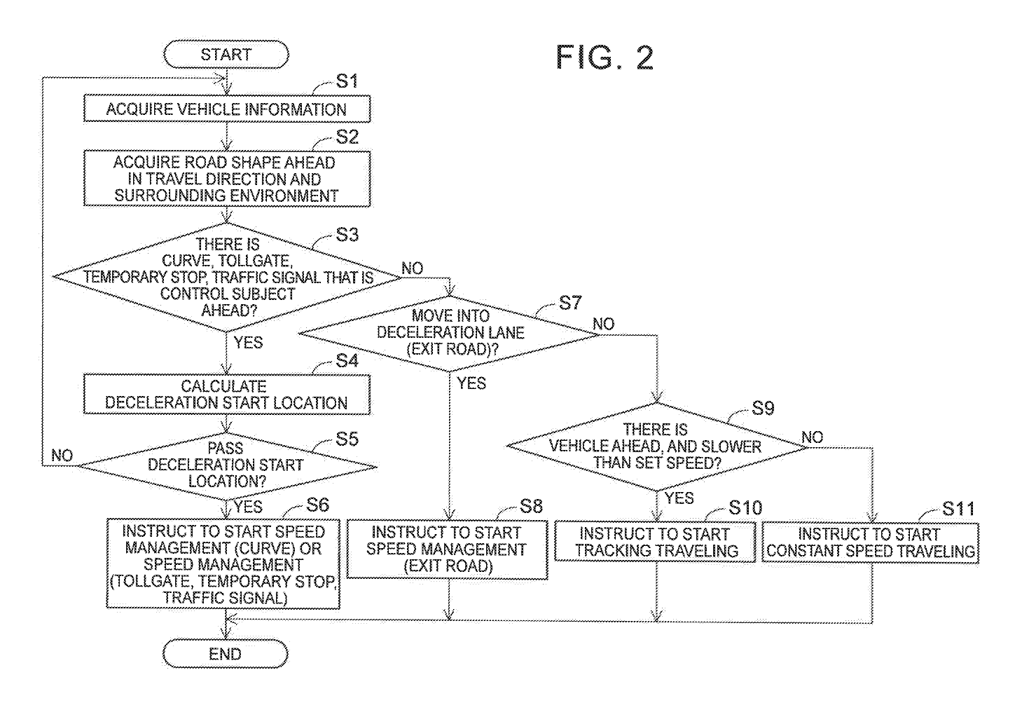

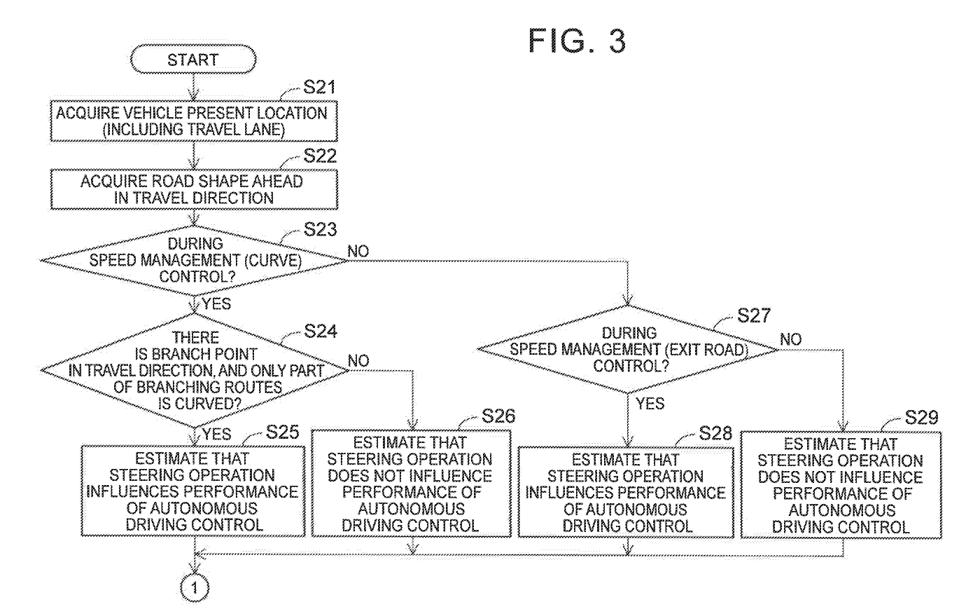

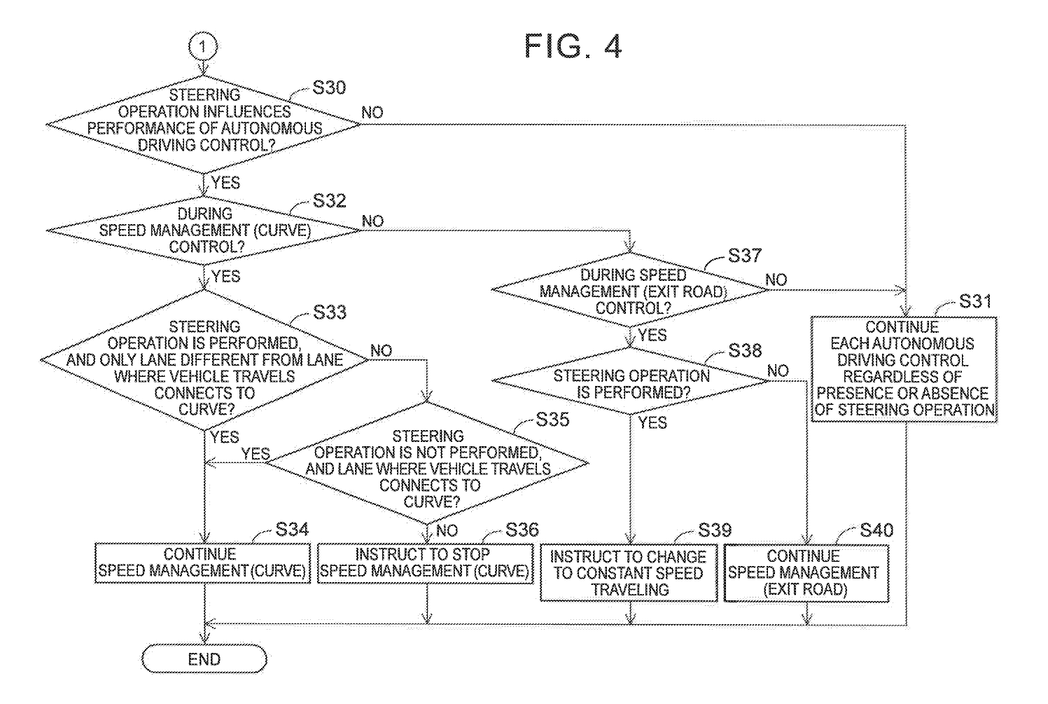

On the other hand, the navigation electronic control unit (ECU) 13 is an electronic control unit for performing overall control of the navigation device 1 and has a CPU 41, serving as a computation device and a control device, and internal storage devices including the following: a RAM 42 that is used as a working memory when the CPU 41 performs various computations and that stores data, such as route data on a found route; a ROM 43 that stores a control program, a later-described autonomous driving start program (refer to FIG. 2), a later-described autonomous driving control change program (refer to FIG. 3 and FIG. 4), etc.; and a flash memory 44 that stores programs read out from the ROM 43. It is noted that the navigation ECU 13 structures various means as processing algorithms. For example, control content setting means sets control content of autonomous driving control in accordance with a situation of the vehicle. Control performing means performs the autonomous driving control in compliance with the set control content. Operation detecting means detects a vehicle operation performed by a driver of the vehicle that travels by using the autonomous driving control. Road shape acquiring means acquires the shape of a road where the vehicles travels. Operation requirement determining means determines, on the basis of the road shape and the control content of the autonomous driving control being performed in the vehicle, whether the situation requires a driver to perform the vehicle operation in order to allow the vehicle to continue the autonomous driving control. Control manner changing means continues or stops the autonomous driving control being performed in the vehicle, or changes the control content thereof, on the basis of the results determined by the operation detecting means and the operation requirement determining means.

The operating portion 14 is operated, for example, to input a departure location as a travel starting point and a destination as a travel ending point, and has multiple operating switches (not illustrated), such as a key and a button. In response to switch signals that are outputted when the switches are operated, such as being pressed down, the navigation ECU 13 performs control to execute corresponding tasks. The operating portion 14 may have a touch panel provided on the front of the liquid crystal display 15. Further, the operating portion 14 may have a microphone and a voice recognition device.

The liquid crystal display 15 displays, for example, the following: a map image that includes roads; traffic information; an operating guide; an operating menu; a key guide; guidance information corresponding to a guide route (planned travel route); news; weather forecast; the time of day; an email; and a television program. Further, according to the present embodiment, when the traveling that uses the autonomous driving control is started or when the traveling that uses the autonomous driving control is stopped, a related notification is displayed. A HUD or HMD may be used instead of the liquid crystal display 15.

The vehicle can have traveling modes including manual driving traveling in which the vehicle travels in response to a driving operation by a user, and traveling that uses autonomous driving control in which the vehicle autonomously travels on a preset route or along a road without a driving operation by a user. In the autonomous driving control, for example, the present location of the vehicle, a lane where the vehicle travels, and locations of other vehicles around are detected at all times, and the vehicle control ECU 20 autonomously performs vehicle control of a steering wheel, a driving source, a brake, etc. so that the vehicle travels on a preset route or along a road. According to the present embodiment, during the traveling that uses the autonomous driving control, the vehicle travels in the same lane without making a lane change nor making a right or left turn unless a user performs a vehicle operation for a lane change or for a right or left turn.

According to the present embodiment, in particular, five kinds of autonomous driving control described below are performed,

(1) ‘Constant speed traveling’ . . . The vehicle travels in the same lane at a preset speed (e.g., 90% of the speed limit of the road where the vehicle travels).
(2) ‘Tracking traveling’ . . . The vehicle travels in the same lane while maintaining a predetermined distance (e.g., 10 m) from a vehicle ahead as far as within a set speed (e.g., 90% of the speed limit of the road where the vehicle travels).
(3) ‘Speed management (curve)’ . . . When there is a curve ahead in the direction of travel, the vehicle decelerates to a speed corresponding to the radius of curvature of the curve before entering the curve.
(4) ‘Speed management (exit road)’ . . . The vehicle is limited in acceleration when traveling in a deceleration lane (exit road) provided on a highway or the like.
(5) ‘Speed management (tollgate, temporary stop, traffic signal)’ . . . When there is a tollgate, a temporary stop, or a traffic signal ahead in the direction of travel, the vehicle decelerates to a speed (e.g., 20 km/h) that allows the vehicle to stop, without putting strain on an occupant, before reaching the tollgate, the temporary stop (road sign), or the traffic signal. Further, in parallel with the above control (1) to (5), control (6) that causes the vehicle to travel almost in the middle of a lane without deviating from the lane lane keeping assist) is performed.

The autonomous driving control (1) to (6) described above may be performed in any road section, and alternatively, may be performed only while the vehicle travels on a highway that has a gate (regardless of whether it is manned, unmanned, tolled, or untolled) at the border with another road connected thereto. It is noted that the autonomous driving control is not always performed when the vehicle travels in a section (hereinafter referred to as an autonomous driving section) where autonomous driving is allowed. The autonomous driving control is performed only when a user chooses to perform the autonomous driving control and when it is determined that the vehicle is allowed to travel by using the autonomous driving control. The vehicle is not allowed to travel by using the autonomous driving control, for example, when weather is bad or when pavement markings have faded away or gotten so light that the camera cannot recognize them.

Further, when a specific vehicle operation (hereinafter referred to as an override), such as accelerating, braking, or steering, performed by a user is detected while the vehicle travels by using the autonomous driving control, the autonomous driving control is stopped in some cases. For example, when a braking operation by a user is detected, the above controls (1) to (5) are stopped. Further, when a steering operation by a user is detected, the above controls (1) to (5) are basically continued, hut the control (6) is temporarily stopped until the operation is finished. However, according to the present embodiment, as described later, when the shape of the surrounding road or the control content of the autonomous driving control being performed satisfies a predetermined condition, the controls (1) to (5) may be stopped upon detection of a steering operation by a user.

The speaker 16 outputs, on the basis of an instruction from the navigation ECU 13, voice guidance for traveling along a guide route and traffic information guidance. Further, according to the present embodiment, when the traveling that uses the autonomous driving control is started or when the traveling that uses the autonomous driving control is stopped, related voice guidance is outputted.

The DVD drive 17 is a drive capable of reading data recorded on a recording medium such as a DVD or CD. On the basis of read data, the DVD drive 17 plays back music and video, updates the map information DB 31, etc. The DVD drive 17 may be replaced with a card slot for reading and writing a memory card.

The communication module 18 is a communication device for receiving traffic information, probe information, weather information, etc., transmitted from a traffic information center, such as a VICS center or a probe center. For example, the communication module 18 corresponds to a mobile phone or DCM. Further, a vehicle-to-vehicle communication device for performing vehicle-to-vehicle communications and a vehicle to roadside communication device for performing vehicle-to-roadside communications are also included.

The vehicle exterior camera 19 is, for example, a camera with a solid-state image sensing device, such as a CCD, and is installed on the upper part of the front bumper of the vehicle with its optical axis angled downward by a predetermined degree relative to the horizontal. When the vehicle travels in the autonomous driving section, the vehicle exterior camera 19 captures an image of the area ahead of the vehicle in the direction of travel. The vehicle control ECU 20 processes the captured image to detect pavement markings on the road where the vehicle travels, other vehicles around, etc., and performs the autonomous driving control of the vehicle on the basis of the detected results. Instead of on the front of the vehicle, the vehicle exterior camera 19 may be installed on the back or side. As means for detecting other vehicles, a sensor, such as a millimeter-wave radar, vehicle-to-vehicle communications, or vehicle-to-roadside communications may be used instead of a camera. As means for detecting weather in surrounding areas, an illuminance sensor or a precipitation sensor may be installed.

The vehicle control ECU 20 is an electronic control unit for controlling the vehicle equipped with the navigation device 1. The vehicle control ECU 20 is connected to drive systems of the vehicle including a steering wheel, a brake, and an accelerator. According to the present embodiment, in particular, after the autonomous driving control is started in the vehicle, the vehicle control ECU 20 performs the autonomous driving control of the vehicle by controlling the drive systems. Further, when a user makes the override during the autonomous driving control, the vehicle control ECU 20 detects that the override is made.

After the start of travel, the navigation ECU 13 transmits an instruction signal related to the autonomous driving control to the vehicle control ECU 20 via CAN. In response to the received instruction signal, the vehicle control ECU 20 performs the autonomous driving control after the start of travel. The instruction signal contains information including the control content of the autonomous driving control of the vehicle (e.g., any of the above (1) to (6)) and an instruction for starting, stopping, or changing control. Instead of the navigation ECU 13, the vehicle control ECU 20 may be structured to set the control content of the autonomous driving control. In this case, the vehicle control ECU 20 is structured to acquire, from the navigation device 1, information necessary for setting the autonomous driving control, such as a planned travel route (guide route), vehicle conditions, or map information on surrounding areas.

Next, an autonomous driving start program executed by the CPU 41 of the navigation device 1 having the above structure according to the present embodiment is described with reference to FIG. 2. FIG. 2 is a flowchart of the autonomous driving start program according to the present embodiment. The autonomous driving start program is executed after an ACC power of the vehicle is turned on, and starts the autonomous driving control of the vehicle when a predetermined condition is met. The programs illustrated in the flowcharts of FIG. 2 to FIG. 4 are stored in the RAM 42 or the ROM 43 of the navigation device 1 and are executed by the CPU 41.

In the autonomous driving start program, the CPU 41 first acquires, in step (hereinafter abbreviated as S) 1, vehicle information related to its own vehicle. Specifically, the CPU 41 acquires the present location of the vehicle detected by the present location detecting unit 11 and the present vehicle speed of the vehicle detected by the vehicle speed sensor 23. It is preferable that the present location of the vehicle be precisely identified by high-accuracy location technology.

Then, in S2, the CPU 41 acquires the shape of a road ahead in the direction of travel of the vehicle and the surrounding environment, for example, by reading information from the map information DB 31, by acquiring the result detected by the vehicle exterior camera 19 or other sensors, or by communicating with an external server, such as a VICS center or a probe center. As the shape of the road ahead in the direction of travel of the vehicle, the CPU 41 acquires, for example, information on whether there is a curve section, a tollgate, a temporary stop, a traffic signal, or a deceleration lane on a route within one kilometer from the present location of the vehicle along the road (a guide route, if the guide route is already set in the navigation device 1). When there is a curve, the CPU 41 also acquires the radius of curvature of the curve and a start point where the curve starts. As the surrounding environment, the CPU 41 acquires, for example, the locations of other vehicles around its own vehicle.

Then, in S3, the CPU 41 determines, on the basis of the vehicle information acquired in S1 and the road shape acquired in S2, whether there is any of a curve, a tollgate, a temporary stop (road sign), and a traffic signal that are each a control subject section ahead in the direction of travel of the vehicle. The control subject section is a section where the vehicle is subjectable to special control (e.g., deceleration control), other than the constant speed traveling and the tracking traveling, of the autonomous driving control when traveling there.

Then, if the CPU 41 determines that there is any of a curve, a tollgate, a temporary stop (road sign), and a traffic signal ahead in the direction of travel of the vehicle (YES in S3), the program proceeds to S4. In contrast, if the CPU 41 determines that there is not any of a curve, a tollgate, a temporary stop (road sign), and a traffic signal ahead in the direction of travel of the vehicle (NO in S3), the program proceeds to S7.

If determining that there is a curve ahead in the direction of travel, in S4, the CPU 41 calculates, on the basis of the present vehicle speed of the vehicle and a distance to the start point of the curve, a location (deceleration start location) where the vehicle needs to start decelerating so that the vehicle can decelerate to a speed corresponding to the radius of curvature of the curve before entering the curve. Likewise, if determining that there is a tollgate, a temporary stop (road sign), or a traffic signal ahead in the direction of travel, the CPU 41 calculates, on the basis of the present vehicle speed of the vehicle and a distance to the tollgate, the temporary stop (road sign), or the traffic signal, a location (deceleration start location) where the vehicle needs to start decelerating so that the vehicle can decelerate to a speed (e.g., 20 km/h) that allows the vehicle to stop, without putting strain on an occupant, before reaching the tollgate, the temporary stop (road sign), or the traffic signal.

Then, in S5, the CPU 41 determines whether the vehicle passes the deceleration start location calculated in S4.

If the CPU 41 determines that the vehicle passes the deceleration start location calculated in S4 (YES in S5), the program proceeds to S6. In contrast, if the CPU 41 determines that the vehicle does not pass the deceleration start location calculated in S4 (NO in S5), the program returns to S1.

If determining that there is a curve ahead in the direction of travel, in S6, the CPU 41 instructs the vehicle control ECU 20 to start the ‘speed management (curve)’. In contrast, if determining that there is a tollgate, a temporary stop (road sign), or a traffic signal ahead in the direction of travel, the CPU 41 instructs the vehicle control ECU 20 to start the ‘speed management (tollgate, temporary stop, traffic signal)’. As a result, the vehicle control ECU 20 that receives the instruction signal starts processing related to the autonomous driving control, and the vehicle starts using the autonomous driving control to travel. The ‘speed management (curve)’ is control that allows the vehicle to decelerate to the speed corresponding to the radius of curvature of the curve before entering the curve. The ‘speed management (tollgate, temporary stop, traffic signal)’ is control that allows the vehicle to decelerate to the speed (e.g., 20 km/h) that allows the vehicle to stop, without putting strain on an occupant, before reaching the tollgate, the temporary stop (road sign), or the traffic signal. In the autonomous driving control, control that causes the vehicle to travel almost in the middle of a lane without deviating from the lane is performed in parallel with the above control.

It is noted that the autonomous driving control is not always performed in S6 when it is determined in S5 that the determination condition is met. The autonomous driving control is performed in S6 only when a user chooses to perform the autonomous driving control by operating the operating button 21, such as the autonomous driving start button, mounted on the vehicle and when it is determined that the vehicle is allowed to travel by using the autonomous driving control. The autonomous driving control is not performed, for example, when weather is bad or when pavement markings have faded away or gotten so light that the camera cannot recognize them.

In contrast, in S7, the CPU 41 determines, on the basis of the vehicle information acquired in S1 and the road shape acquired in S2, whether the vehicle moves into a deceleration lane (exit road) that is the control subject section. The deceleration lane is provided, for example, at an interchange or junction of a highway to allow vehicles to exit main lanes. Further, the deceleration lane is provided to allow vehicles to enter a rest area or a parking area.

If the CPU 41 determines that the vehicle moves into the deceleration lane (exit road) (YES in S7), the program proceeds to S8. In contrast, if the CPU 41 determines that the vehicle does not move into the deceleration lane (exit road) (NO in S7), the program proceeds to S9.

In S8, the CPU 41 instructs the vehicle control ECU 20 to start the ‘speed management (exit road)’. As a result, the vehicle control ECU 20 that receives the instruction signal starts processing related to the autonomous driving control, and the vehicle starts using the autonomous driving control to travel. The ‘speed management (exit road)’ is control that does not allow the vehicle to accelerate even when the vehicle speed of the vehicle is slower than a set speed (e.g., 90% of the speed limit of the road where the vehicle travels). In the autonomous driving control, control that causes the vehicle to travel almost in the middle of a lane without deviating from the lane is performed in parallel with the above control.

It is noted that the autonomous driving control is not always performed in S8 when it is determined in S7 that the determination condition is met. The autonomous driving control is performed in S8 only when a user chooses to perform the autonomous driving control by operating the operating button 21, such as the autonomous driving start button, mounted on the vehicle and when it is determined that the vehicle is allowed to travel by using the autonomous driving control. The autonomous driving control is not performed, for example, when weather is bad or when pavement markings have faded away or gotten so light that the camera cannot recognize them.

In contrast, in S9, the CPU 41 determines, on the basis of the vehicle information acquired in S1 and the surrounding environment, whether there is another vehicle ahead and whether the present vehicle speed of the vehicle is slower than a set speed (e.g., 90% of the speed limit of the road where the vehicle travels).

If the CPU 41 determines that there is the other vehicle ahead and that the present vehicle speed of the vehicle is slower than the set speed (YES in S9), the program proceeds to S10. In contrast, if the CPU 41 determines that there is no vehicle ahead or that the present vehicle speed of the vehicle is faster than the set speed (NO in S9), the program proceeds to S11.

In S10, the CPU 41 instructs the vehicle control ECU 20 to start the ‘tracking traveling’. As a result, the vehicle control ECU 20 that receives the instruction signal starts processing related to the autonomous driving control, and the vehicle starts using the autonomous driving control to travel. The ‘tracking traveling’ is control that allows the vehicle to travel while maintaining a predetermined distance (e.g., 10 m) from another vehicle ahead as far as within a set speed (e.g., 90% of the speed limit of the road where the vehicle travels). In the autonomous driving control, control that causes the vehicle to travel almost in the middle of a lane without deviating from the lane is performed in parallel with the above control.

In contrast, in S11, the CPU 41 instructs the vehicle control ECU 20 to start the ‘constant speed traveling’. As a result, the vehicle control ECU 20 that receives the instruction signal starts processing related to the autonomous driving control, and the vehicle starts using the autonomous driving control to travel. The ‘constant speed traveling’ is control that allows the vehicle to travel at a preset speed (e.g., 90% of the speed limit of the road where the vehicle travels). In the autonomous driving control, control that causes the vehicle to travel almost in the middle of a lane without deviating from the lane is performed in parallel with the above control.

It is noted that the autonomous driving control is not always performed in S10 or S11 when it is determined in S9 that the determination condition is met or not met. The autonomous driving control is performed in S10 or S11 only when a user chooses to perform the autonomous driving control by operating the operating button 21, such as the autonomous driving start button, mounted on the vehicle and when it is determined that the vehicle is allowed to travel by using the autonomous driving control. The autonomous driving control is not performed, for example, when weather is bad or when pavement markings have faded away or gotten so light that the camera cannot recognize them.

Next, the autonomous driving control change program executed by the CPU 41 of the navigation device 1 having the above structure according to the present embodiment is described with reference to FIG. 3 and FIG. 4. FIG. 3 and FIG. 4 are flowcharts of the autonomous driving control change program according to the present embodiment. The autonomous driving control change program is executed when the vehicle travels by using the autonomous driving control. On the basis of presence or absence of detection of the override and the shape of the surrounding road, the autonomous driving control change program continues or stops the autonomous driving control, or changes the control content thereof.

First, in S21, the CPU 41 acquires the present location of the vehicle. It is preferable that the present location of the vehicle be precisely identified by high-accuracy location technology and that which lane the vehicle travels in be identified when the vehicle travels on a multiple lane road.

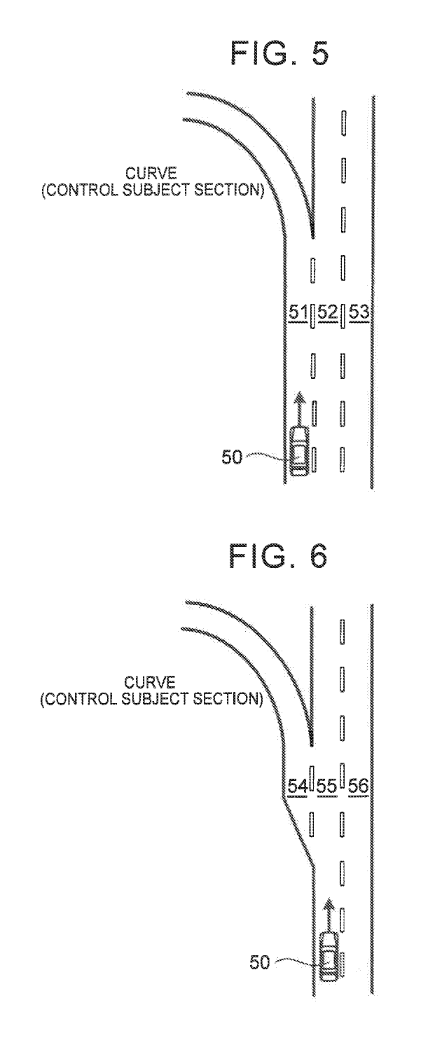

Then, in S22, the CPU 41 acquires the shape of the road ahead in the direction of travel of the vehicle, for example, by reading information from the map information DB 31, by acquiring the result detected by the vehicle exterior camera 19 or other sensors, or by communicating with an external server, such as a VICS center or a probe center. In particular, when there is a branch point ahead in the direction of travel of the vehicle, the CPU 41 also acquires information on lane demarcation, road connection for each lane, and a road shape of each route after the branch point. For example, when the vehicle 50 travels in a road section as illustrated in FIG. 5, the CPU 41 acquires information that the road has three lanes 51 to 53 and branches, at a branch point ahead in the direction of travel, into different routes, one of which has the lane 51, and the other has the lanes 52 and 53. Further, the CPU 41 acquires information that the route connected to the lane 51 is curved after the branch point and that the route connected to the lanes 52 and 53 remains straight after the branch point.

Then, in S23, the CPU 41 acquires the control state of the autonomous driving control by communicating with the vehicle control ECU 20 via CAN and determines whether the vehicle is performing the ‘speed management (curve)’ of the autonomous driving control.

If the CPU 41 determines that the vehicle is performing the ‘speed management (curve)’ of the autonomous driving control (YES in S23), the program proceeds to S24. In contrast, if the CPU 41 determines that the vehicle is not performing the ‘speed management (curve)’ of the autonomous driving control (NO in S23), the program proceeds to S27.

In S24, the CPU 41 determines, on the basis of the road shape acquired in S22, whether there is a branch point ahead in the direction of travel of the vehicle and whether only part of branching routes has a curve that is the control subject section. For example, when the road shape is like what is illustrated in FIG. 5 or FIG. 6, the CPU 41 determines in S24 that only part of the branching routes has a curve that is the control subject section. In the example illustrated in FIG. 5, the lane 51 as part of the multiple lanes 51 to 53 that form the road connects to a curved road that branches off from the other lanes 52 and 53. On the other hand, in the example illustrated in FIG. 6, a new lane 54 is added, and the added lane 54 branches of from other lanes 55 and 56 and connects to a curved road.

If the CPU 41 determines that only part of the branching routes has a curve that is the control subject section (YES in S24), the program proceeds to S25. In contrast, if the CPU 41 determines that there is no branch point ahead in the direction of travel or determines that although there is a branch point, each branching route has a curve that is the control subject section (NO in S24), the program proceeds to S26.

In S25, the CPU 41 estimates that the override, in particular, a steering operation for making a lane change influences the performance of the autonomous driving control presently being performed. For example, in the situation illustrated in FIG. 5, when the vehicle 50 makes a lane change to the right, so that a lane where the vehicle 50 travels changes from the lane 51 to the lane 52, the vehicle 50 will not travel in a curve section later. Therefore, the ‘speed management (curve)’ of the autonomous driving control needs to be stopped when being performed for the curve ahead. On the other hand, in the situation illustrated in FIG. 6, when the vehicle 50 keeps in the lane 55 or the lane 56 without making a lane change to the lane 54, the vehicle 50 will not travel in a curve section later. Therefore, the ‘speed management (curve)’ of autonomous driving control needs to be stopped when being performed for the curve ahead.

In contrast, in S26, the CPU 41 estimates that the override, in particular, a steering operation for making a lane change does not influence the performance of the autonomous driving control presently being performed. That is, since the vehicle will travel in a curved section later whichever lane the vehicle travels in, no problem occurs when the ‘speed management (curve)’ of the autonomous driving control is continuously performed for the curve ahead, regardless of whether the vehicle makes a lane change.

In S27, the CPU 41 acquires the control state of the autonomous driving control by communicating with the vehicle control ECU 20 via CAN and determines whether the vehicle is performing the ‘speed management (exit road)’ of the autonomous driving control.

If the CPU 41 determines that the vehicle is performing the ‘speed management (exit road)’ of the autonomous driving control (YES in S27), the program proceeds to S28. In contrast, if the CPU 41 determines that the vehicle is not performing the ‘speed management (exit road)’ of the autonomous driving control either, i.e., determines that the vehicle is performing any of the ‘constant speed traveling’, the ‘tracking traveling’, and the ‘speed management (tollgate, temporary stop, traffic signal)’ of the autonomous driving control (NO in S27), the program proceeds to S29.

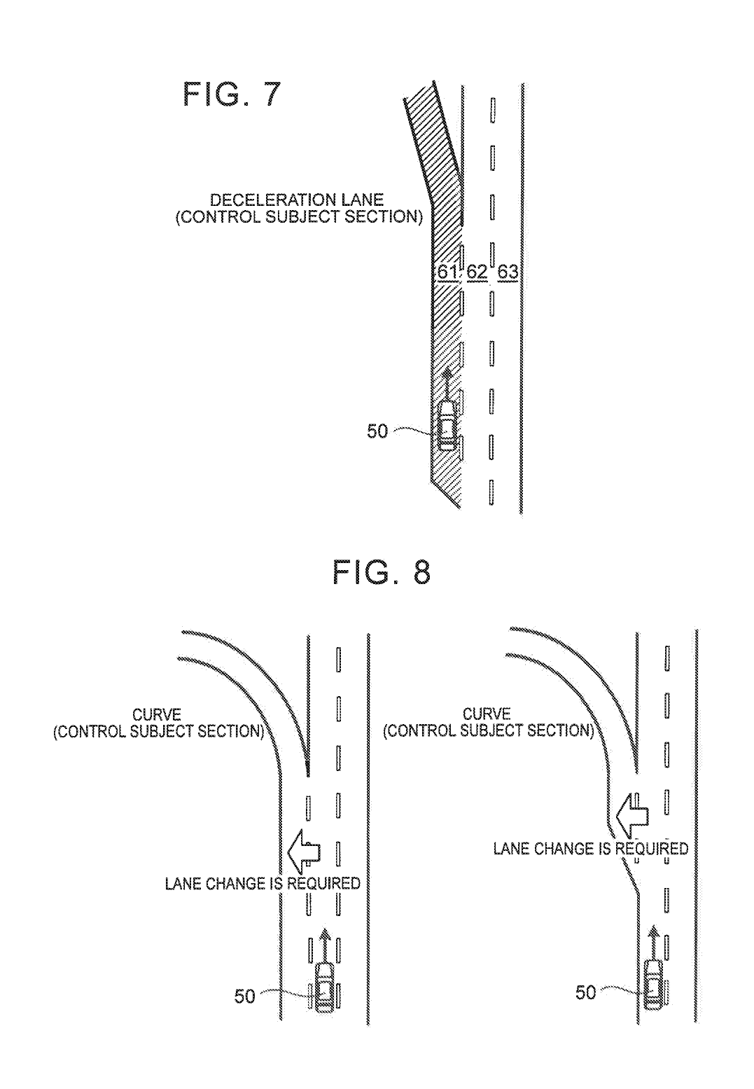

In S28, the CPU 41 estimates that the override, in particular, a steering operation for making a lane change influences the performance of the autonomous driving control presently being performed. For example, as illustrated in FIG. 7, when the vehicle 50 travels in a lane 61 that is a deceleration lane, the ‘speed management (exit road)’ of the autonomous driving control is basically performed. However, when the vehicle 50 makes a lane change and moves into a lane 62 or a lane 63 that is not a deceleration lane, the vehicle 50 will not travel in a deceleration lane later. Therefore, the ‘speed management (exit road)’ of the autonomous driving control needs to be stopped when being performed for a deceleration lane.

In contrast, in S29, the CPU 41 estimates that the override, in particular, a steering operation for making a lane change does not influence the performance of the autonomous driving control presently being performed. For example, when the ‘constant speed traveling’ or the ‘tracking traveling’ is being performed, continuously performing the autonomous driving control causes no problem whichever lane the vehicle moves into. Further, when the ‘speed management (tollgate, temporary stop, traffic signal)’ is being performed, the vehicle will reach a tollgate, a temporary stop, or a traffic signal later whichever lane the vehicle travels in. In this case, therefore, continuously performing the ‘speed management (tollgate, temporary stop, traffic signal)’ of the autonomous driving control for the tollgate, the temporary stop, or the traffic signal ahead causes no problem, regardless of whether the vehicle makes a lane change.

Then, in S30, the CPU 41 determines, on the basis of the result estimated in S25, S26, S28, or S29, whether the override, in particular, a steering operation for making a lane change influences the performance of the autonomous driving control presently being performed.

If the CPU 41 determines that a steering operation for making a lane change influences the performance of the autonomous driving control presently being performed (YES in S30), the program proceeds to S32. In contrast, if the CPU 41 determines that a steering operation for making a lane change does not influence the performance of the autonomous driving control presently being performed (NO in S30), the program proceeds to S31. In S31, regardless of whether a steering operation for making a lane change is made, the CPU 41 continues the autonomous driving control presently being performed.

In contrast, in S32, the CPU 41 acquires the control state of the autonomous driving control by communicating with the vehicle control ECU 20 via CAN and determines whether the vehicle is performing the ‘speed management (curve)’ of the autonomous driving control.

If the CPU 41 determines that the vehicle is performing the ‘speed management (curve)’ of the autonomous driving control (YES in S32), the program proceeds to S33. In contrast, if the CPU 41 determines that the vehicle is not performing the ‘speed management (curve)’ of the autonomous driving control (NO in S32), the program proceeds to S37.

In S33, the CPU 41 determines, on the basis of the present location of the vehicle acquired in S21, the road shape acquired in S22, and an override operation detected by the vehicle control ECU 20, whether a steering operation for making a lane change is performed and whether only a lane different from the lane where the vehicle travels until the operation is performed connects to a curve. Here, “the situation where only a lane different from the lane where the vehicle travels connects to a curve” refers to, for example, a situation illustrated in FIG. 8, where in order to allow the vehicle that travels by using the ‘speed management (curve)’ of the autonomous driving control to continue the autonomous driving control, a driver is required to perform a vehicle operation (specifically, a steering operation for making a lane change) so as to move into a lane connecting to a curve.

In a case where the CPU 41 determines that a steering operation for making a lane change is performed and that only a lane different from the lane where the vehicle travels until the operation is performed connects to a curve (YES in S33), the autonomous driving control being performed is continued (S34) because this case occurs when a driver performs a vehicle operation in a situation where the driver is required to perform the vehicle operation in order to allow the vehicle that travels by using the autonomous driving control to continue the autonomous driving control. In contrast, if a steering operation for making a lane change is not performed, or the lane where the vehicle travels until the operation is performed connects to a curve (S33 in NO), the program proceeds to S35.

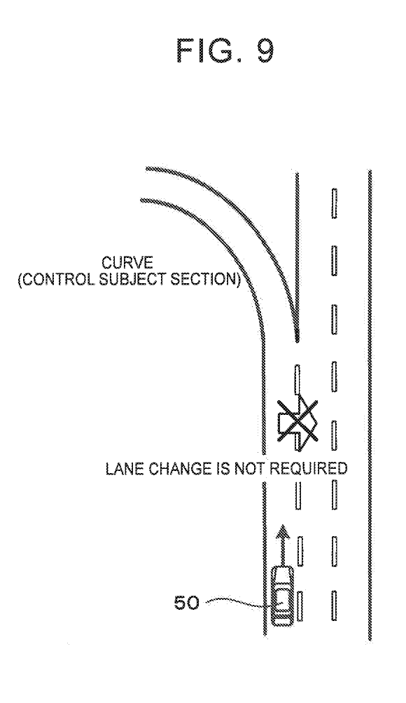

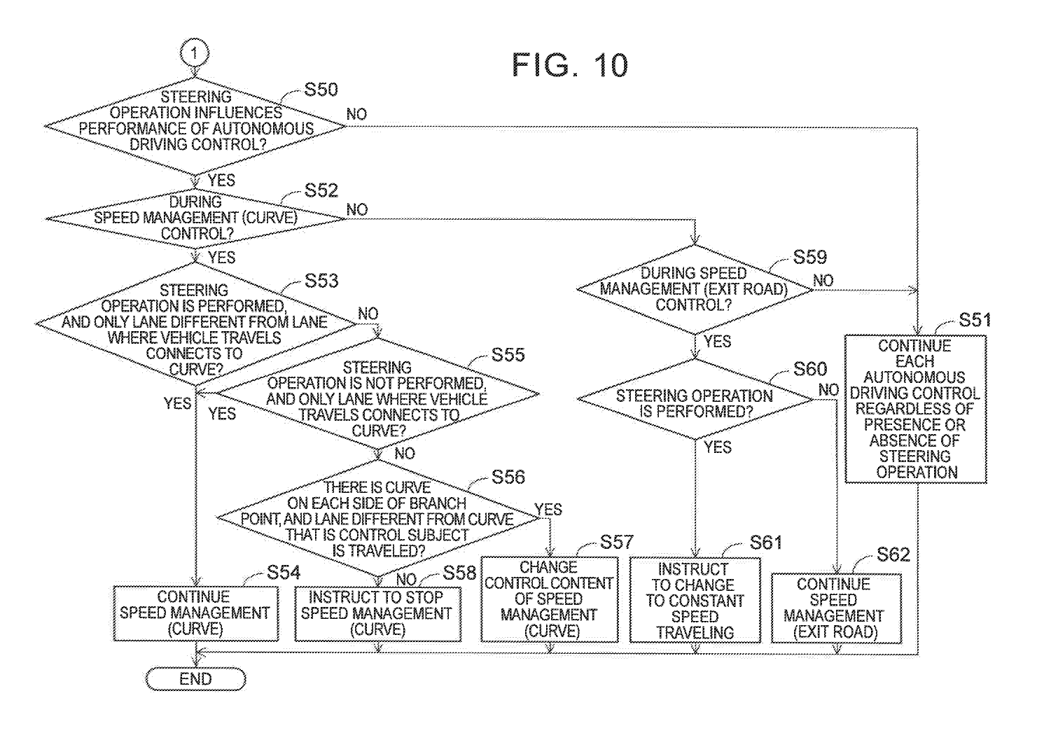

In S35, the CPU 41 determines, on the basis of the present location of the vehicle acquired in S21, the road shape acquired in S22, and the override operation detected by the vehicle control ECU 20, whether a steering operation for making a lane change is not performed and whether the lane where the vehicle travels connects to a curve. Here, “the situation where the lane where the vehicle travels connects to a curve” refers to, for example, a situation illustrated in FIG. 9, where in order to allow the vehicle that travels by using the ‘speed management (curve)’ of the autonomous driving control to continue the autonomous driving control, a driver is required to keep in the present lane without performing a vehicle operation (specifically, a steering operation for making a lane change).

In a case where the CPU 41 determines that a steering operation for making a lane change is not performed and that the lane where the vehicle travels connects to a curve (YES in S35), the autonomous driving control being performed is continued (S34) because this case occurs when a driver does not perform a vehicle operation in a situation where the driver is not required to perform the vehicle operation in order to allow the vehicle that travels by using the autonomous driving control to continue the autonomous driving control.

In contrast, in a case where the CPU 41 determines that a steering operation for making a lane change is not performed and that only a lane different from the lane where the vehicle travels connects to a curve (NO in S35), the vehicle control ECU 20 is instructed to stop the autonomous driving control being performed (S36) because this case occurs when a driver does not perform the vehicle operation in a situation (for example, in the situation illustrated in FIG. 8) where the driver is required to perform the vehicle operation in order to allow the vehicle that travels by using the autonomous driving control to continue the autonomous driving control.

Likewise, in a case where the CPU 41 determines that a steering operation for making a lane change is performed and that the lane where the vehicle travels until the operation is performed connects to a curve (NO in S35), the vehicle control ECU 20 is instructed to stop the autonomous driving control being performed (S36) because this case occurs when a driver performs a vehicle operation in a situation (for example, in the situation illustrated in FIG. 9) where the driver is not required to perform the vehicle operation in order to allow the vehicle that travels by using the autonomous driving control to continue the autonomous driving control. This prevents the ‘speed management (curve)’ of the autonomous driving control from being continued when the vehicle is expected not to travel in a curve later.

Alternatively, in S36, the control content may be changed from the ‘speed management (curve)’ to another of the autonomous driving control (e.g., the ‘constant speed traveling’ or the ‘tracking traveling’) without stopping the autonomous driving control. Further, control (e.g., lane keeping assist) that causes the vehicle to travel almost in the middle of a lane without deviating from the lane may be continued when the ‘speed management (curve)’ is stopped.

In S37, the CPU 41 acquires the control state of the autonomous driving control by communicating with the vehicle control ECU 20 via CAN and determines whether the vehicle is performing the ‘speed management (exit road)’ of the autonomous driving control.

If the CPU 41 determines that the vehicle is performing the ‘speed management (exit road)’ of the autonomous driving control (YES in S37), the program proceeds to S38. Here, the situation where the ‘speed management (exit road)’ of the autonomous driving control is being performed refers to, for example, the situation illustrated in FIG. 7, where in order to allow the vehicle that travels by using the ‘speed management (curve)’ of the autonomous driving control to continue the autonomous driving control, a driver is required to keep in the present lane without performing a vehicle operation (specifically, a steering operation for making a lane change).

In contrast, if the CPU 41 determines that the vehicle is not performing the ‘speed management (exit road)’ of the autonomous driving control either, i.e., determines that the vehicle is performing any of the ‘constant speed traveling’, the ‘tracking traveling’, and the ‘speed management (tollgate, temporary stop, traffic signal)’ of the autonomous driving control (NO in S37), the program proceeds to S31. In S31, regardless of whether a steering operation for making a lane change is made, the CPU 41 continues the autonomous driving control presently being performed.

In S38, the CPU 41 determines, on the basis of an override operation detected by the vehicle control ECU 20, whether the override, in particular, a steering operation for making a lane change is made.

In a case where the CPU 41 determines that a steering operation for making a lane change is performed (YES in S38), the vehicle control ECU 20 is instructed to change the autonomous driving control to be performed to the ‘constant speed traveling’ (S39) because this case occurs when a driver performs a vehicle operation in a situation (for example, in the situation illustrated in FIG. 7) where the driver is not required to perform the vehicle operation in order to allow the vehicle that travels by using the autonomous driving control to continue the autonomous driving control. This prevents the ‘speed management (exit road)’ of the autonomous driving control from being continued after the vehicle returns to a main lane from a deceleration lane (exit road). Alternatively, in S39, the autonomous driving control may be stopped.

In contrast, in a case where the CPU 41 determines that a steering operation for making a lane change is not performed (NO in S38), the autonomous driving control being performed is continued (S40) because this case occurs when a driver does not perform a vehicle operation in a situation (for example, in the situation illustrated in FIG. 7) where the driver is not required to perform the vehicle operation in order to allow the vehicle that travels by using the autonomous driving control to continue the autonomous driving control.

As described in detail above, the navigation device 1 according to the present embodiment, an autonomous driving assistance method by the navigation device 1, and a computer program executed in the navigation device 1 performs autonomous driving control by setting control content of the autonomous driving control in accordance with a situation of a vehicle (S3 to S11) and determines, on the basis of the shape of a road where the vehicle travels and the control content of the autonomous driving control being performed in the vehicle, whether the situation requires a driver to perform a vehicle operation in order to allow the vehicle to continue the autonomous driving control, and continues or stops the control content of the autonomous driving control being performed in the vehicle, or changes the control content thereof, on the basis of the determined result and presence or absence of the vehicle operation by a driver (S31, S34, S36, S39, S40). Thus, if the vehicle operation by a driver is detected, there is no possibility that all the autonomous driving control is equally stopped in the same manner as in the related art. This makes it possible to continue the autonomous driving control, for example, in a situation where the autonomous driving control does not need to be stopped, thus preventing an increase in the burden on a driver in driving the vehicle, associated with stopping the autonomous driving control. Further, in a situation where the autonomous driving control needs to be stopped, this makes it possible to continue the autonomous driving control by changing the control content thereof, thus preventing an increase in the burden on a driver in driving the vehicle, associated with stopping the autonomous driving control.

It is noted that various improvements and modifications are possible without departing from the spirit of the inventive principles.

For example, the autonomous driving control change program (FIG. 3 and FIG. 4) executed by the CPU 41 of the navigation device 1 according to the present embodiment may be structured as described below. FIG. 10 illustrates a modification of the autonomous driving assistance program according to the present embodiment.

Since procedures in S50 to S54 are the same as the procedures in S30 to S34, their description is omitted. Further, the program proceeds to S50 after the procedures in S21 to S29 are executed.

First, in S55, the CPU 41 determines, on the basis of the present location of the vehicle acquired in S21, the road shape acquired in S22, and an override operation detected by the vehicle control ECU 20. Whether a steering operation for making a lane change is not performed and whether only a lane where the vehicle travels connects to a curve. Here, “the situation where only the lane where the vehicle travels connects to a curve” refers to, for example, the situation illustrated in FIG. 9, where in order to allow the vehicle that travels by using the ‘speed management (curve)’ of the autonomous driving control to continue the autonomous driving control, a driver is required to keep in the present lane to travel without performing a vehicle operation (specifically, a steering operation for making a lane change).

In a case where the CPU 41 determines that a steering operation for making a lane change is not performed and that only the lane where the vehicle travels connects to a curve (YES in S55), the autonomous driving control being performed is continued (S54) because this case occurs when a driver does not perform a vehicle operation in a situation where the driver is not required to perform the vehicle operation in order to allow the vehicle that travels by using the autonomous driving control to continue the autonomous driving control.

In contrast, if the CPU 41 determines that a steering operation for making a lane change is not performed and that a lane different from the lane where the vehicle travels also connects to a curve or the lane where the vehicle travels does not connect to a curve (NO in S55), the program proceeds to S56.

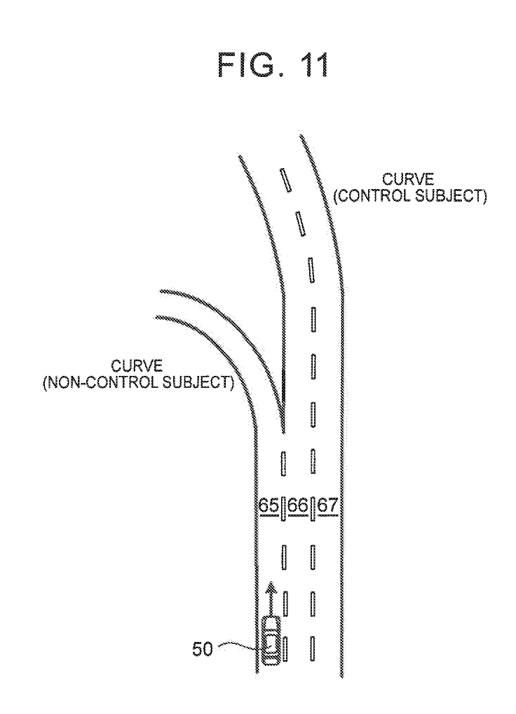

In S56, the CPU 41 determines, on the basis of the present location of the vehicle acquired in S21 and the road shape acquired in S22, whether branching lanes each connect to curves and whether the vehicle travels in a lane different from a lane connecting to a curve that is the control subject for the ‘speed management (curve)’. Here, “the vehicle travels in a lane different from a lane connecting to a curve that is the control subject for the ‘speed management (curve)’” refers to, for example, a situation illustrated in FIG. 11, where lanes 65 to 67 each connect to curves after branching off and where the vehicle 50 travels in the lane 65 connecting to a curve that is not the control subject for the ‘speed management (curve)’ of the autonomous driving control, without traveling in the lanes 66 and 67 connecting to a curve that is the control subject for the ‘speed management (curve)’ of the autonomous driving control.

If the CPU 41 determines that the branching lanes each connect to curves and that the vehicle travels in a lane different from a lane connecting to a curve that is the control subject for the ‘speed management (curve)’ (YES in S56), the control content of the ‘speed management (curve)’ is changed (S57). Specifically, when a distance to the deceleration start location for the curve connected to the lane where the vehicle travels is less than a distance to the deceleration start location for the curve that is the control subject for the ‘speed management (curve)’, the deceleration rate is increased in accordance with the deceleration start location for the curve connected to the lane where the vehicle travels. In contrast, when the distance to the deceleration start location for the curve connected to the lane where the vehicle travels is larger than the distance to the deceleration start location for the curve that is the control subject for the ‘speed management (curve)’, the deceleration rate is reduced in accordance with the deceleration start location for the curve connected to the lane where the vehicle travels.

In contrast, a case where the CPU 41 determines that none of the branching lanes connects to a curve (NO in S56) occurs when a driver does not perform a vehicle operation in a situation (for example, in the situation illustrated in FIG. 8) where the driver is required to perform the vehicle operation in order to allow the vehicle that travels by using the autonomous driving control to continue the autonomous driving control, or occurs when a driver performs a vehicle operation in a situation (for example, in the situation illustrated in FIG. 9) where the driver is not required to perform the vehicle operation in order to allow the vehicle that travels by using the autonomous driving control to continue the autonomous driving control. Therefore, the vehicle control ECU 20 is instructed to stop the autonomous driving control being performed (S58). This prevents the ‘speed management (curve)’ of the autonomous driving control from being continued when the vehicle is expected not to travel in a curve later.

If the CPU 41 determines that the branching lanes each connect to curves and that the vehicle travels in a lane connecting to a curve that is the control subject for the ‘speed management (curve)’, the presently performed ‘speed management (curve)’ control is continued.

Since subsequent procedures in S59 to S62 are the same as the procedures in S37 to S40, their description is omitted.

Although, according to the present embodiment, any of (1) to (6) described above is performed as the autonomous driving control, control other than (1) to (6) may be performed. For example, acceleration control, stop control, or control related to a right or left turn or a lane change may be performed.

Although, according to the present embodiment, a determination whether to continue or stop the autonomous driving control being performed in the vehicle, or change the control content thereof is made on the basis of whether, the override, in particular, the steering operation for making a lane change is made, the determination may be made on the basis of an override other than a steering operation for making a lane change. For example, the determination may be made on the basis of an accelerator operation or a brake operation.

Although, according to present embodiment, the navigation device 1 executes the autonomous driving start program (refer to FIG. 2) and the autonomous driving control change program (refer to FIG. 3 and FIG. 4), the vehicle control ECU 20 may execute them instead. In this case, the vehicle control ECU 20 is structured to acquire, from the navigation device 1, the present location of the vehicle, map information, etc.

According to the description of the present embodiment, the autonomous driving control for allowing the vehicle to travel autonomously without a driving operation by a driver means that the vehicle control ECU 20 controls, out of vehicle operations, all of an accelerator operation, a brake operation, and a steering operation that are operations associated with the behavior of the vehicle. Alternatively, the autonomous driving control may mean that the vehicle control ECU 20 controls, out of vehicle operations, at least one of an accelerator operation, a brake operation, and a steering operation that are operations associated with the behavior of the vehicle. On the other hand, the manual driving by a driving operation of a user means that a user performs, out of vehicle operations, all of an accelerator operation, a brake operation, and a steering operation that are operations associated with the behavior of the vehicle.

Exemplary embodiments riot only to a navigation device but also to a device that is communicatively connected to the vehicle control ECU 20. For example, embodiments include a mobile phone, a smartphone, a tablet terminal, a personal computer, etc. (hereinafter referred to as a mobile terminal or the like). Further, embodiments include a system having a server and the mobile terminal or the like. In this case, either the server or the mobile terminal or the like executes any step in the autonomous driving start program (refer to FIG. 2) and the autonomous driving control change program (refer to FIGS. 3, 4). However, in embodiments including the mobile terminal or the like, a vehicle that is allowed to perform the autonomous driving control and the mobile terminal or the like need to be communicatively connected to each other (in a wired or wireless manner).

While the autonomous driving assistance system is described above with reference to the embodiment, the autonomous driving assistance system can have structures and effects described below.

For example, a first structure includes the following: vehicle location acquiring means for acquiring a present location of a vehicle; road shape acquiring means for acquiring a road shape of a road where the vehicle travels; control content setting means for setting, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape; control performing means for performing the first autonomous driving control or the second autonomous driving control in compliance with the control content set by the control content setting means; operation detecting means for detecting a steering operation by a driver of the vehicle; and control manner changing means for continuing or stopping the first autonomous driving control or the second autonomous driving control being performed in the vehicle, on the basis of a result detected by the operation detecting means, the present location of the vehicle, and the road shape of the road where the vehicle travels. The autonomous driving assistance system having the above structure determines, on the basis of presence or absence of detection of the steering operation by the driver, the shape of the surrounding road, and the content of the autonomous driving control being performed, whether to continue or stop the autonomous driving control in the vehicle that travels by using the autonomous driving control. Thus, if the steering operation by the driver is detected, there is no possibility that all the autonomous driving control is equally stopped in the same manner as in the related art. This makes it possible to prevent an increase in the burden on the driver in driving the vehicle, associated with stopping the autonomous driving control.

A second structure is as follows: the road shape acquiring means acquires, as lane-related information, lane demarcation on the road where the vehicle travels and road connection for each lane; when the operation detecting means detects the steering operation by the driver, the control manner changing means determines, on the basis of the lane-related information and the road shape of the road where the vehicle travels, whether only a lane different from a lane where the vehicle presently stays corresponds to a performance subject lane where the second autonomous driving control is to be performed; and when determining that only the lane different from the lane where the vehicle presently stays corresponds to the performance subject lane, the control manner changing means continues the second autonomous driving control being performed in the vehicle. The autonomous driving assistance system having the above structure, if the steering operation by the driver is detected, continues the autonomous driving control in a situation where the autonomous driving control does not need to be stopped. This makes it possible to prevent the increase in the burden on the driver in driving the vehicle, associated with stopping the autonomous driving control.

A third structure is as follows: the road shape acquiring means acquires, as lane-related information, lane demarcation on the road where the vehicle travels and road connection for each lane; while the operation detecting means does not detect the steering operation by the driver, the control manner changing means determines, on the basis of the lane-related information and the road shape of the road where the vehicle travels, whether only a lane different from a lane where the vehicle presently stays corresponds to a performance subject lane where the second autonomous driving control is to be performed; and when determining that only the lane different from the lane where the vehicle presently stays corresponds to the performance subject lane, the control manner changing means stops the second autonomous driving control being performed in the vehicle. The autonomous driving assistance system having the above structure, when the steering operation by the driver is not detected, allows the autonomous driving control to be stopped in a situation where the autonomous driving control needs to be stopped. This makes it possible to perform the autonomous driving control in accordance with a change in the situation of the vehicle, caused by the fact that the vehicle operation is not performed.

A fourth structure is as follows: the road shape acquiring means acquires, as lane-related information, lane demarcation on the road where the vehicle travels and road connection for each lane; while the operation detecting means does not detect the steering operation by the driver, the control manner changing means determines, on the basis of the lane-related information and the road shape of the road where the vehicle travels, whether only a lane where the vehicle presently stays corresponds to a performance subject lane where the second autonomous driving control is to be performed; and when determining that only the lane where the vehicle presently stays corresponds to the performance subject lane, the control manner changing means continues the second autonomous driving control being performed in the vehicle. The autonomous driving assistance system having the above structure continuously performs the autonomous driving control when the steering operation by the driver is not detected, thus making it possible to continuously perform the autonomous driving control necessary for the situation of the vehicle.

A fifth structure is as follows: the road shape acquiring means acquires, as lane-related information, lane demarcation on the road where the vehicle travels and road connection for each lane; when the operation detecting means detects the steering operation by the driver, the control manner changing means determines, on the basis of the lane-related information and the road shape of the road where the vehicle travels, whether only a lane where the vehicle presently stays corresponds to a performance subject lane where the second autonomous driving control is to be performed; and when determining that only the lane where the vehicle presently stays corresponds to the performance subject lane, the control manner changing means stops the second autonomous driving control being performed in the vehicle. The autonomous driving assistance system having the above structure allows the autonomous driving control to be stopped when the steering operation by the driver is detected in a situation where the autonomous driving control needs to be stopped. This makes it possible to perform the autonomous driving control in accordance with a change in the situation of the vehicle, caused by the vehicle operation.

A sixth structure is as follows: when the road where the vehicle travels has a branch point, the road shape acquiring means acquires, as branch-point-related information, lane demarcation, road connection for each lane, and a road shape of each route after the branch point; while the operation detecting means does not detect the steering operation by the driver, the control manner changing means determines, on the basis of the branch-point-related information and the road shape of the road where the vehicle travels, whether each lane branching off at the branch point of the road has a performance subject lane where the second autonomous driving control is to be performed and whether a lane where the vehicle presently stays is different from a performance subject lane where the second autonomous driving control is to be performed presently; and when determining that each lane branching off at the branch point of the road has the performance subject lane and that the lane where the vehicle presently stays is different from the performance subject lane where the second autonomous driving control is to be performed presently, the control manner changing means changes the control content of the second autonomous driving control being performed in the vehicle. The autonomous driving assistance system having the above structure allows the control content of the autonomous driving control to be changed as necessary when the steering operation by the driver is not detected. This makes it possible to perform the autonomous driving control in accordance with a change in the situation of the vehicle.

A seventh structure is as follows: the performance subject lane is a lane connecting to a curve or is a deceleration lane. The autonomous driving assistance system having the above structure makes it possible to correctly determine, on the basis of the lane demarcation and whether each lane connects to a curve or a deceleration lane, whether to continue or stop the autonomous driving control.

An eighth structure is as follows: the road shape acquiring means acquires deceleration lane information that identifies a deceleration lane on the road; the control content setting means sets, on the basis of the present location of the vehicle and the deceleration lane information, the control content of the first autonomous driving control and the second autonomous driving control for the deceleration lane; and when the operation detecting means detects the steering operation by the driver while the control performing means performs the first autonomous driving control and the second autonomous driving control in compliance with the control content that the control content setting means sets for the deceleration lane, the control performing means changes the control content of the first autonomous driving control and the second autonomous driving control from the control content for the deceleration lane to the control content for allowing the vehicle to travel in the same lane at a preset speed. The autonomous driving assistance system having the above structure allows the control content of the autonomous driving control to be changed when the steering operation by the driver is detected. This makes it possible to perform the autonomous driving control in accordance with a change in the situation of the vehicle, caused by the vehicle operation.

A ninth structure is as follows: when the operation detecting means detects the steering operation by the driver, the control manner changing means temporarily stops the first autonomous driving control until the operation is finished. The autonomous driving assistance system having the above structure makes it possible to appropriately perform the autonomous driving control that causes the vehicle to travel without deviating from a lane when the steering operation by the driver is detected.

A tenth structure is as follows: the control manner changing means further includes operation requirement determining means for determining, on the basis of the road shape of the road where the vehicle travels and the control content of the second autonomous driving control being performed in the vehicle, whether a situation requires the driver to perform the steering operation in order to allow the vehicle to continue the second autonomous driving control; and the control manner changing means continues or stops the second autonomous driving control being performed in the vehicle, on the basis of the result detected by the operation detecting means and a result determined by the operation requirement determining means. The autonomous driving assistance system having the above structure determines, on the basis of presence or absence of detection of the steering operation by the driver, the shape of the surrounding road, and the content of the autonomous driving control being performed, whether to continue or stop the autonomous driving control in the vehicle that travels by using the autonomous driving control. Thus, if the vehicle operation by the driver is detected, there is no possibility that all the autonomous driving control is equally stopped as in the same manner as in the related art. This prevents an increase in the burden on the driver in driving the vehicle, associated with stopping the autonomous driving control.

An eleventh structure is as follows: when there is a control subject section ahead in a direction of travel of the vehicle, the control content of the second autonomous driving control being performed in the vehicle is control for traveling in the control subject section, and only a lane different from a lane where the vehicle travels connects to the control subject section, the operation requirement determining means determines that the situation requires the driver to perform the steering operation in order to allow the vehicle to continue the second autonomous driving control. The autonomous driving assistance system having the above structure makes it possible to correctly determine whether the situation requires the driver to perform the steering operation in order to allow the vehicle to continue the autonomous driving control.

A twelfth structure is as follows: influence estimating means for estimating whether the steering operation by the driver influences performance of the second autonomous driving control is included; and when it is estimated that the steering operation by the driver influences the performance of the second autonomous driving control, the control manner changing means continues or stops the second autonomous driving control being performed in the vehicle, on the basis of the result detected by the operation detecting means and the result determined by the operation requirement determining means. The autonomous driving assistance system having the above structure makes it possible to determine whether to continue or stop the autonomous driving control on the basis of the steering operation by the driver, only when it is estimated that the steering operation by the driver influences the performance of the autonomous driving control.

A thirteenth structure is as follows: when there is a branch point ahead in a direction of travel of the vehicle, and only part of routes branching off at the branch point has the control subject section, the influence estimating means estimates that the steering operation by the driver influences the performance of the second autonomous driving control. The autonomous driving assistance system having the above structure makes it possible to correctly estimate when the steering operation by the driver influences the performance of the autonomous driving control.

A fourteenth structure is as follows: the road shape acquiring means acquires deceleration lane information that identifies a deceleration lane on the road; the control content setting means sets, on the basis of the present location of the vehicle and the deceleration lane information, the control content of the first autonomous driving control and the second autonomous driving control for the deceleration lane; and when the first autonomous driving control and the second autonomous driving control are performed in compliance with the control content that the control content setting means sets for the deceleration lane, the influence estimating means estimates that the steering operation by the driver influences the performance of the second autonomous driving control. The autonomous driving assistance system having the above structure makes it possible to correctly estimate when the steering operation by the driver influences the performance of the autonomous driving control.

A fifteenth structure is as follows: the control subject section is a curve or a deceleration lane; when the control subject section is the curve, the control content setting means sets the control content of the second autonomous driving control that causes deceleration to the speed corresponding to a radius of curvature of the curve before entry to the curve; and When the control subject section is the deceleration lane, the control content setting means sets the control content of the second autonomous driving control that limits acceleration. The autonomous driving assistance system having the above structure makes it possible to perform the autonomous driving control in accordance with the situation of the vehicle.

1. An autonomous driving assistance system comprising:
a processor programmed to:
acquire a present location of a vehicle;
acquire a road shape of a road where the vehicle travels;
set, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape;
perform the first autonomous driving control or the second autonomous driving control in compliance with the set control content;
detect a steering operation by a driver of the vehicle; and
continue or stop the first autonomous driving control or the second autonomous driving control being performed in the vehicle, on the basis of the detected steering operation, the present location of the vehicle, and the road shape of the road where the vehicle travels.

2. The autonomous driving assistance system according to claim 1, wherein the processor is programmed to:
acquire, as lane-related information, lane demarcation on the road where the vehicle travels and road connection for each lane;
when the steering operation is detected, determine, on the basis of the lane-related information and the road shape of the road where the vehicle travels, whether only a lane different from a lane where the vehicle presently stays corresponds to a performance subject lane where the second autonomous driving control is to be performed; and
when determining that only the lane different from the lane where the vehicle presently stays corresponds to the performance subject lane, continue the second autonomous driving control being performed in the vehicle.

3. The autonomous driving assistance system according to claim 1, wherein the processor is programmed to:
acquire, as lane-related information, lane demarcation on the road where the vehicle travels and road connection for each lane;
while the steering operation is not detected, determine, on the basis of the lane-related information and the road shape of the road where the vehicle travels, whether only a lane different from a lane where the vehicle presently stays corresponds to a performance subject lane where the second autonomous driving control is to be performed; and
when determining that only the lane different from the lane where the vehicle presently stays corresponds to the performance subject lane, stop the second autonomous driving control being performed in the vehicle.

4. The autonomous driving assistance system according to claim 1, wherein the processor is programmed to:
acquire, as lane-related information, lane demarcation on the road where the vehicle travels and road connection for each lane;
while the steering operation is not detected, determine, on the basis of the lane-related information and the road shape of the road where the vehicle travels, whether only a lane where the vehicle presently stays corresponds to a performance subject lane where the second autonomous driving control is to be performed; and
when determining that only the lane where the vehicle presently stays corresponds to the performance subject lane, continue the second autonomous driving control being performed in the vehicle.

5. The autonomous driving assistance system according to claim 1, wherein the processor is programmed to:
acquire, as lane-related information, lane demarcation on the road where the vehicle travels and road connection for each lane;
when the steering operation is detected, determine, on the basis of the lane-related information and the road shape of the road where the vehicle travels, whether only a lane where the vehicle presently stays corresponds to a performance subject lane where the second autonomous driving control is to be performed; and
when determining that only the lane where the vehicle presently stays corresponds to the performance subject lane, the control manner changing means stops the second autonomous driving control being performed in the vehicle.

6. The autonomous driving assistance system according to claim 1, wherein the processor is programmed to:
when the road where the vehicle travels has a branch point, acquire, as branch-point-related information, lane demarcation, road connection for each lane, and a road shape of each route after the branch point;
while the steering operation is not detected, determine, on the basis of the branch-point-related information and the road shape of the road where the vehicle travels, whether each lane branching off at the branch point of the road has a performance subject lane where the second autonomous driving control is to be performed and whether a lane where the vehicle presently stays is different from a performance subject lane where the second autonomous driving control is to be performed presently; and
when determining that each lane branching off at the branch point of the road has the performance subject lane and that the lane where the vehicle presently stays is different from the performance subject lane where the second autonomous driving control is to be performed presently, change the control content of the second autonomous driving control being performed in the vehicle.

7. The autonomous driving assistance system according to claim 2, wherein
the performance subject lane is a lane connecting to a curve or is a deceleration lane.

8. The autonomous driving assistance system according to claim 1, wherein the processor is programmed to:
acquire deceleration lane information that identifies a deceleration lane on the road;
set, on the basis of the present location of the vehicle and the deceleration lane information, the control content of the first autonomous driving control and the second autonomous driving control for the deceleration lane; and
when the steering operation is detected while the first autonomous driving control and the second autonomous driving control is performed in compliance with the set control content for the deceleration lane, change the control content of the first autonomous driving control and the second autonomous driving control from the control content for the deceleration lane to the control content for allowing the vehicle to travel in the same lane at a preset speed.

9. The autonomous driving assistance system according to claim 1, wherein the processor is programmed to:
when the steering operation is detected, temporarily stop the first autonomous driving control until the steering operation is finished.

10. The autonomous driving assistance system according to claim 1, wherein the processor is programed to:
determine, on the basis of the road shape of the road where the vehicle travels and the control content of the second autonomous driving control being performed in the vehicle, whether a situation requires the driver to perform the steering operation in order to allow the vehicle to continue the second autonomous driving control; and
continue or stop the second autonomous driving control being performed in the vehicle, on the basis of the determination of whether the steering operation is performed and the determination of whether a situation requires the driver to perform the steering operation in order to allow the vehicle to continue the second autonomous driving control.

11. The autonomous driving assistance system according to claim 10, wherein the processor is programmed to:
when there is a control subject section ahead in a direction of travel of the vehicle, the control content of the second autonomous driving control being performed in the vehicle is control for traveling in the control subject section, and only a lane different from a lane where the vehicle travels connects to the control subject section, determine that the situation requires the driver to perform the steering operation in order to allow the vehicle to continue the second autonomous driving control.

12. The autonomous driving assistance system according to claim 10, wherein the processor is programmed to:
estimate whether the steering operation by the driver influences performance of the second autonomous driving control; and
when it is estimated that the steering operation by the driver influences the performance of the second autonomous driving control, continue or stop the second autonomous driving control being performed in the vehicle, on the basis of the determination of whether the steering operation is performed and the determination of whether a situation requires the driver to perform the steering operation in order to allow the vehicle to continue the second autonomous driving control.

13. The autonomous driving assistance system according to claim 12, wherein the processor is programmed to:
when there is a branch point ahead in a direction of travel of the vehicle, and only part of routes branching off at the branch point has the control subject section, estimate that the steering operation by the driver influences the performance of the second autonomous driving control.

14. The autonomous driving assistance system according to claim 12, wherein the processor is programmed to:
acquire deceleration lane information that identifies a deceleration lane on the road;
set, on the basis of the present location of the vehicle and the deceleration lane information, the control content of the first autonomous driving control and the second autonomous driving control for the deceleration lane; and
when the first autonomous driving control and the second autonomous driving control are performed in compliance with the set control content for the deceleration lane, estimate that the steering operation by the driver influences the performance of the second autonomous driving control.

15. The autonomous driving assistance system according to claim 10, wherein
the control subject section is a curve or a deceleration lane; and
the processor is programmed to:
when the control subject section is the curve, set the control content of the second autonomous driving control that causes deceleration to the speed corresponding to a radius of curvature of the curve before entry to the curve; and
when the control subject section is the deceleration lane, set the control content of the second autonomous driving control that limits acceleration.

16. An autonomous driving assistance method comprising:
acquiring a present location of a vehicle;
acquiring a road shape of a road where the vehicle travels;
setting, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape;
performing the first autonomous driving control or the second autonomous driving control in compliance with the set control content;
detecting a steering operation by a driver of the vehicle; and
continuing or stopping the first autonomous driving control or the second autonomous driving control being performed in the vehicle, on the basis of the detected steering operation, the present location of the vehicle, and the road shape of the road where the vehicle travels.

17. A computer-readable storage medium storing a computer-executable program for causing a computer to perform the following functions:
acquiring a present location of a vehicle;
acquiring a road shape of a road where the vehicle travels;
setting, on the basis of the present location of the vehicle and the road shape of the road where the vehicle travels, control content of first autonomous driving control that causes the vehicle to travel without deviating from a lane and second autonomous driving control that controls a speed of the vehicle in accordance with the road shape;
performing the first autonomous driving control or the second autonomous driving control in compliance with the set control content;
detecting a steering operation by a driver of the vehicle; and
continuing or stopping the first autonomous driving control or the second autonomous driving control being performed in the vehicle, on the basis of the detected steering operation, the present location of the vehicle, and the road shape of the road where the vehicle travels.
